(19) United States
(12) Patent Application Publication
(10) Pub. No.: US 2014/0268795 A1
(43) Pub. Date: Sep. 18, 2014

(54) Apparatus for Color Correcting a Beam of Light

(71) Applicant: SYNCROLITE, LLC, DALLAS, TX (US)

(72) Inventor: Jack CALMES, Dallas, TX (US)

(73) Assignee: SYNCROLITE, LLC, DALLAS, TX (US)

(21) Appl. No.: 14/208,732

(22) Filed: Mar. 13, 2014

Related U.S. Application Data
(60) Provisional application No. 61/800,307, filed on Mar. 15, 2013.
(60) Provisional application No. 61/803,026, filed on Mar. 18, 2013.

(51) Int. Cl. G02B 5/22; F21V 9/08

(52) U.S. Cl. CPC G02B 5/22; F21V 9/08
USPC 362/293; 359/891

(57) ABSTRACT

An apparatus for color correcting a light beam and a lighting fixture including such an apparatus are provided. The apparatus includes filter wheels with color correction filter regions and clear substrate regions. Some of the filter wheels can be rotated into corresponding first positions that produce a predetermined minimal amount of color correction, and can be rotated into corresponding second positions that produce a predetermined maximal amount of color correction.

### CROSS-REFERENCE TO RELATED APPLICATIONS AND CLAIM OF PRIORITY

The present application is related to U.S. Provisional Patent Application No. 61/800,307, filed Mar. 15, 2013, entitled “VARIABLE COLOR CORRECTION FRONT END FOR LIGHTING FIXTURES AND RELATED SYSTEM AND METHOD,” and to U.S. Provisional Patent Application No. 61/803,026, filed Mar. 18, 2013, entitled “VARIABLE COLOR CORRECTION FRONT END FOR LIGHTING FIXTURES AND RELATED SYSTEM AND METHOD.” Provisional Patent Applications Nos. 61/800,307 and 61/803,026 are assigned to the assignee of the present application and are hereby incorporated by reference into the present application as if fully set forth herein. The present application hereby claims priority under 35 U.S.C. §119(e) to both U.S. Provisional Application Patent No. 61/800,307 and to U.S. Provisional Patent Application No. 61/803,026.

### TECHNICAL FIELD

This disclosure relates generally to lighting equipment. More specifically, this disclosure relates to an apparatus for color correcting a light beam, for use in a lighting fixture.

### BACKGROUND

Light that is referred to as “white” may actually be any of a number of near-white colors. The particular color of white light is often expressed as a “color temperature” in degrees Kelvin (° K). As an illustration, “white” light produced by an arc light source may have a bluish tint (approximately 6200° K), while “white” light produced by an incandescent source may have an orange tint (approximately 3200° K). Natural sunlight falls between the two, at 5600° K.

Where a lighting fixture having an arc or incandescent light source is used to supplement natural sunlight for photography or cinematography purposes, the difference in color temperature between the natural light and the supplemental light is likely to be detectable in the resulting film or video image. Additionally, some film stocks (film types) are formulated to be used with a particular type of lighting source (for example, daylight or incandescent). When such stocks are used with light of another color temperature, objects that are actually white appear in the resulting image to be tinted, rather than white.

Filters have been developed that change (or “correct”) the color temperature of a light beam emitted by the fixture. Such filters are typically referred to as “color correction filters.” Color correction may also be abbreviated as “CC.” In one example, CC filters may be placed over the aperture of a lighting fixture, thereby enabling an arc or incandescent source to be used as supplemental lighting in a scene predominantly lit by daylight. In a second example, a CC filter may be placed in front of the lens of a camera, to allow film stock formulated for incandescent light to be used to film a scene lit by arc lights.

### SUMMARY

To address the above-discussed deficiencies of the prior art, it is a primary object to provide, for use in an apparatus for color correcting a light beam, for use in a lighting fixture.

An apparatus for color correcting a light beam is provided. The apparatus includes filter wheels having regions comprising a color correction filter and regions comprising a clear substrate. Some of the filter wheels are configured to rotate into corresponding first positions that produce a predetermined minimal amount of color correction, and to rotate into corresponding second positions that produce a predetermined maximal amount of color correction.

A lighting fixture is provided. The lighting fixture includes a light source configured to emit a light beam. The lighting fixture also includes color correction apparatus configured to color correct a portion of the light beam. The color correction apparatus includes filter wheels having regions comprising a color correction filter and regions comprising a clear substrate. Some of the filter wheels are configured to rotate into corresponding first positions that produce a predetermined minimal amount of color correction, and to rotate into corresponding second positions that produce a predetermined maximal amount of color correction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 presents an orthogonal view of a first apparatus in accordance with the described embodiments;

FIG. 2 depicts a front view of a first filter wheel in accordance with the described embodiments;

FIG. 3 presents an orthogonal view of a second apparatus in accordance with the described embodiments;

FIG. 4 depicts a front view of a second filter wheel in accordance with the described embodiments;

FIG. 5 presents a schematic view of a first lighting fixture in accordance with the described embodiments;

FIG. 6 presents a schematic view of a second lighting fixture in accordance with the described embodiments;

FIG. 7 presents a schematic view of a third apparatus in accordance with the described embodiments;

FIG. 8 presents a schematic view of a control system in accordance with the described embodiments; and

FIG. 9 presents a front view of the first apparatus of FIG. 1.

### DETAILED DESCRIPTION

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus for color correcting a light beam, for use in a lighting fixture.

FIG. 1 presents an orthogonal view of a first apparatus 100 in accordance with the described embodiments. The apparatus 100 includes filter wheels 102a, 102b, and 102c. As will be discussed in more detail with reference to FIG. 2, the filter wheels 102 include clear portions and color correction (“CC”) filter portions. As will be discussed in more detail with reference to FIG. 5 and FIG. 6, the apparatus 100 is typically positioned in front of, or in, a lighting fixture, such that substantially all of a beam of light emitted by the lighting fixture passes through the filter wheels 102 of the apparatus 100.

The filter wheels 102a and 102b are rotatably mounted in the apparatus 100 by supports 104. While four supports 104 are shown in apparatus 100, other embodiments according to the disclosure may include more or fewer supports. The supports 104 include rollers in contact with an outer surface of the filter wheels 102a and 102b. In other embodiments according to the disclosure, the supports 104 may include low-friction channels to engage an outer portion of the filter wheels 102a and 102b. In still other embodiments, other suitable mechanisms may be used to allow the supports 104 to support and constrain the position of the wheels 102a and 102b, while allowing the wheels to rotate about a common axis of rotation.

In the embodiment of the disclosure shown in FIG. 1, the filter wheel 102c is fixedly mounted in the apparatus 100 and does not rotate. In other embodiments of the disclosure, all three of the filter wheels 102 may rotate.

FIG. 2 depicts a front view of a first filter wheel 102 in accordance with the described embodiments. The filter wheel 102 has angular regions 202 of CC filter subtending 30 degrees of arc alternating with angular regions 204 of clear substrate material subtending 60 degrees of arc. The filter wheel 102 could be formed from any suitable material(s) and in any suitable manner. The clear substrate material may be glass in some embodiments and conventional gel material in other embodiments. The CC filter may be a partially reflective dichroic coating in some embodiments and an absorptive filter in other embodiments.

Referring again to FIG. 1, where filter wheels 102a, 102b, and 102c have the clear and CC filter regions described with reference to FIG. 2, filter wheels 102a and 102b may be rotated in a first configuration to positions where the CC filter regions of each of the filter wheels 102 are substantially aligned with corresponding CC filter regions of the other filter wheels 102. In this first configuration, a front view of the apparatus 100 would present the same aspect as the view of filter wheel 102 shown in FIG. 2, with all CC filter regions 202 substantially aligned and all clear substrate regions 204 substantially aligned.

In this first configuration, two-thirds of the light beam passing through the filter wheels 102 passes through the clear regions 204, while the remaining one-third of the beam passes through three thicknesses of the CC filter regions 202. As such, the light beam is only partly or minimally color corrected.

In other embodiments, the filter wheels may be configured to rotate into a first configuration in which the CC filter regions 202 are not fully or substantially aligned. In such embodiments, something more that one-third of the light beam will pass through one or more thicknesses of the CC filter regions 202 and something less than two-thirds of the light beam will pass through the clear regions 204. As such, the minimal color correction achieved by such embodiments will be a desired, predetermined, greater amount of color correction than the actual minimum that can physically be achieved with filter wheels having the pattern of filter regions and clear regions shown for the filter wheels 102.

In a second configuration of the apparatus 100, the filter wheel 102a and filter wheel 102b may be rotated by sixty degrees and thirty degrees, respectively, from their positions in the first configuration. In this second configuration, substantially all of the light beam passing through the filter wheels 102 passes through the CC filter regions 202 of one or another of the filter wheels 102. As such, the second configuration applies a maximal color correction in which the light beam is fully color corrected.

FIG. 9 presents a front view of the first apparatus 100 in this second configuration. The CC filter regions of the filter wheels 102a, 102b, and 102c are labeled respectively 202a, 202b, and 202c. It may be seen from FIG. 9 that the CC filter regions of the filter wheels 102 filter substantially all of a light beam passing through the apparatus 100.

In other embodiments, the filter wheels may be configured to rotate into a second configuration in which the CC filter regions 202 do not fully cover the light beam passing therethrough. In such embodiments, this second configuration allows some unfiltered light to pass through the apparatus 100. As such, the maximal color correction achieved by such embodiments will be a desired, predetermined, lesser amount of color correction than the full color correction that can physically be achieved with the filter wheels 102.

It will be understood that the filter wheels 102a and 102b may be rotated to any position relative to the filter wheel 102c, causing some portions of the light beam to pass through only clear substrate regions 204 of the filter wheels 102 and other portions to pass through CC filter regions 202 of one or more of the filter wheels 102. In this way, a specified variable and controllable amount of color correction of the light beam may be applied between the minimal color correction produced in the first configuration of the apparatus 100 and the maximal color correction of the second configuration.

FIG. 3 presents an orthogonal view of a second apparatus 300 in accordance with the described embodiments. The apparatus 300 includes filter wheels 302a and 302b. The filter wheels 302 include clear portions and color correction (“CC”) filter portions. The apparatus 300 is typically positioned in front of, or in, a lighting fixture, such that substantially all of a beam of light emitted by the lighting fixture passes through the filter wheels 302.

The filter wheel 302a is rotatably mounted in the apparatus 300 by supports 304. Other embodiments according to the disclosure may include more or fewer supports than the four supports 304 shown in apparatus 300. The supports 304 may be any suitable mechanism to support and constrain the position of the wheel 302a, while allowing the wheel 302a to rotate.

In the embodiment of the disclosure shown in FIG. 3, the filter wheel 302b is fixedly mounted in the apparatus 300 and does not rotate. In other embodiments of the disclosure, both of the filter wheels 302 may rotate.

FIG. 4 depicts a front view of a second filter wheel 400 in accordance with the described embodiments. The filter wheel 400 is suitable for use in the apparatus 300 shown in FIG. 3. The filter wheel 400 has alternating angular regions 402 of CC filter and regions 204 of clear substrate material. Each of the regions 402 and 404 subtend 22.5 degrees of arc. Referring again to FIG. 3, where filter wheels 302a and 302b have the clear and CC filter regions described with reference to filter wheel 400, filter wheel 302a may be rotated in a first configuration to a position where corresponding CC filter regions of the two filter wheels 302 are substantially aligned. In this first configuration, half of the light beam passing through the filter wheels 302 passes through the clear regions 404, while the other half of the beam passes through two thicknesses of the CC filter regions 202. As such, the light beam is only partly color corrected.

As described with reference to the apparatus 100 shown in FIG. 1, in other embodiments the filter wheels 302 may be configured to rotate into a first configuration that provides a desired, predetermined, minimal color correction that is greater than the actual minimum amount of correction that can be achieved given the pattern of clear regions and CC filter regions on the filter wheels 302.

In a second configuration of the apparatus 300, the filter wheel 302a may be rotated by 22.5 degrees from its position in the first configuration. In this second configuration, substantially all of the light beam passing through the filter wheels 302 passes through the CC filter regions 402 of one or the other of the filter wheels 302. As such, the light beam is fully color corrected.

As described with reference to the apparatus 100 shown in FIG. 1, in other embodiments the filter wheels 302 may be configured to rotate into a second configuration that allows some unfiltered light to pass through the apparatus 300 and provides a desired, predetermined, maximal color correction that is less than fully color corrected.

It will be understood that the filter wheel 302a may be rotated to any position relative to the filter wheel 302b, resulting in a specified variable and controllable amount of color correction of the light beam between the minimal correction produced in the first configuration of the apparatus 300 and the maximal color correction of the second configuration.

While color correction apparatuses having three filter wheels with thirty degree CC filter regions and two filter wheels with 22.5 degree CC filter regions have been shown herein, it will be understood that in other embodiments any suitable number of filter wheels with any suitable number of CC filter regions may be used.

While the filter wheels of the apparatus 100 of FIG. 1 and the apparatus 300 of FIG. 3 are described with identical patterns of CC filter regions and clear substrate regions, it will be understood that in other embodiments some filter wheels may have differing patterns of filter regions and clear regions from other filter wheels in an apparatus according to the disclosure. As described for the apparatus 100 and the apparatus 300, such other embodiments may be configured with a first configuration providing a minimal color correction that is greater than the actual minimum that may be obtained with the filter wheels of the embodiment and/or a second configuration providing a maximal color correction that is less than full color correction.

FIG. 5 presents a schematic view of a first lighting fixture 500 in accordance with the described embodiments. The lighting fixture 500 includes a bulb 502 (or other light source) and a reflector 504 having a generally parabolic cross-section. When the bulb 502 is positioned at or near a focal point of the reflector 504, a light beam comprising substantially parallel light rays is emitted from the lighting fixture 500. The lighting fixture 500 may be referred to as a “wash” or “wash light” and produces a soft-edged light beam. Positioned at an aperture of the lighting fixture 500 is a color correction apparatus 506 according to the disclosure. Substantially all of the light beam emitted by the light fixture 500 passes through the apparatus 506, with the result that a selectable amount of color correction may be applied to the light beam.

The apparatus 506 may be fixedly or removeably mounted to the reflector 504 or to a frame (not shown), which also supports the reflector 504 and the bulb 502. In another embodiment, the lighting fixture 500 further includes a Fresnel lens 508 or other type of lens to diffuse or modify divergence of the light beam emitted by the lighting fixture 500. The lens 508 may be fixedly or removeably mounted to the apparatus 506 or to a frame (not shown), which also supports the apparatus 506, the reflector 504, and the bulb 502.

In other embodiments, the lens 508 may be a holographic lensing material. Such lensing material may be formed on a flexible substrate and mounted on a scrolling mechanism to allow lensing material producing a desired divergence pattern to be scrolled into the light beam passing through the apparatus 506. Thus, in various embodiments, the apparatus 506 may be located within or in front of a wash lighting fixture 500.

FIG. 6 presents a schematic view of a second lighting fixture 600 in accordance with the described embodiments. The lighting fixture 600 is a type of fixture that may be referred to as a “spot” or “profile spot” fixture and produces a hard-edged light beam. The fixture 600 includes a light source 602, comprising a bulb and a reflector. The reflector in the light source 602 has a generally elliptical cross-section and produces a light beam that converges to concentrate substantially all the light produced by the bulb of the light source 602 at a projection gate 604. A pattern 606 or other image may be placed in the projection gate 604. The fixture 600 further includes a projection lens 610, which is positioned relative to the projection gate 604 to project an image 614 of the pattern 606 on a distant surface 612. It will be understood that a spot fixture according to the disclosure may include additional lenses between the light source 602 and the projection lens 610.

A color correction apparatus 608 according to the disclosure may be positioned within the fixture 600 as shown in FIG. 6, between the projection gate 604 and the projection lens 610, such that substantially all of the light beam passing through the projection gate 604 passes through the apparatus 608. In other embodiments, the apparatus 608 may be positioned between the light source 602 and the projection gate 604, again such that substantially all of the light beam converging on the projection gate 604 passes through the apparatus 608. In still other embodiments, the apparatus 608 may be positioned between the projection lens 610 and the surface 612, preferably adjacent to the projection lens 610. In all these embodiments, the apparatus 608 is operable to apply a selectable amount of color correction to the light beam emitted by the fixture 600.

Preferably, the apparatus 608 is positioned in a location where an image of the filter wheels of the apparatus 608 is not projected on the surface 612 by the projection lens 610. Further, the apparatus 608 is positioned in a location where the unfiltered portions of the light beam passing through clear regions of the filter wheels and filtered portions of the light beam passing through CC filter regions of the filter wheels are blended, so that a uniform color is perceived across substantially all of the image 614 projected by the fixture 600.

While the fixture 600 is shown having a pattern 606 in the projection gate 604 and projecting an image 614 on the surface 612, it will be understood that in other embodiments according to the disclosure, no pattern 606 is placed in the projection gate 604. In such embodiments, the projection lens 610 projects an image 614 of the projection gate 604 (typically circular) on the surface 612.

FIG. 7 presents a schematic view of a third apparatus 700 in accordance with the described embodiments. Filter wheels 702a, 702b, and 702c are supported by supports 704. The filter wheels 702a and 702b are rotatably mounted in the supports 704, while the filter wheel 702c is fixedly mounted in the supports 704.

The filter wheels 702a and 702b are coupled, respectively, by coupling members 712a and 712b to actuators 710a and 710b. The actuators 710 and coupling members 712 are configured to rotate their corresponding filter wheels 702 between first and second positions, as described with reference to the apparatus 100 shown in FIG. 1, producing respectively minimal and full color correction filtering of a light beam passing through the apparatus 700.

In a manually operated system, the actuators 710 may be handles or other mechanisms suitable for a user to manipulate the positions of the filter wheels 702a and 702b by hand. In some such embodiments, actuators 710 may be rims of the filter wheels 702, configured to be directly operated by hand.

In an electrically operated system, the actuators 710 may be motors, linear actuators, solenoids, or other suitable electrically activated devices. Where the actuator 710a is a rotary motor, the coupling member 712a may be a belt that transfers rotary motion of a pinion gear on a shaft of the actuator 710a to an outer surface of the filter wheel 702a, causing the filter wheel 702a to rotate in response to rotation of the actuator 710a. Where the actuator 710a is a linear encoder, the coupling member 712a may be a crank arm that pivotally couples a shaft of the actuator 710a to an outer edge of the filter wheel 702a, causing the filter wheel 702a to rotate in response to linear motion of the actuator 710a.

Where the actuators 710 are electrically activated devices, the apparatus 700 may further include a control system 706, electrically coupled to the actuators 710 by a control link 708. The control system 706 will be discussed in greater detail with reference to FIG. 8. Where a plurality of lighting fixtures each includes a color correction apparatus 700, the control systems 706 in each fixture may themselves be communicatively coupled to a system controller (not shown), which commands each apparatus 700 via its control system 706 to apply a specified amount of color correction to the light beam emitted by its associated lighting fixture. It will be understood that the specified amount of color correction may be the same or may be different in individual lighting fixtures.

In another embodiment of the disclosure, a single actuator 710 (either manual or electrical) may be coupled to both filter wheels 702a and 702b by respective coupling members 712a and 712b. Suitable differing mechanical or physical configurations of the coupling members 712 and 712b result in a single motion by the actuator 710 producing differing amounts of rotation in the filter wheels 702a and 702b. For example, in such an embodiment used with the apparatus 100 of FIG. 1, a single motion of the actuator 710 might cause the filter wheels 702a and 702b to rotate by sixty degrees and thirty degrees, respectively.

In still another embodiment of the disclosure, all three filter wheels 702a, 702b, and 702c are rotatably mounted in the supports 704. In such an embodiment, a third actuator 710c may be coupled to the filter wheel 702c by a coupling member 712c and configured to rotate the filter wheel 702c between first and second positions.

FIG. 8 presents a schematic view of a control system 800 in accordance with the described embodiments. The control system includes a controller 802 coupled to memory 804. The controller 802 may be any suitable processing device, such as a microprocessor, microcontroller, programmable gate array (PGA), application-specific integrated circuit (ASIC), or the like. The memory 804 includes any suitable volatile and/or non-volatile storage and retrieval device or devices. The memory 804 may include a combination of such memory types. The memory 804 may store data and instructions adapted to be used by the controller 802 to control a color correction apparatus according to the disclosure.

The controller 802 is also communicatively coupled to actuators 806. In some embodiments, the actuators 806 comprise the electrically operated actuators 710 described with reference to FIG. 7. The controller 802 is configured to control the actuators 806 to position associated filter wheels to produce a specified amount of color correction.

The controller is also communicatively coupled to a communications interface 808. The interface 808 includes a connection 810 accessible to a communication device that is external to the control system 800. The controller 802 is configured to receive via the interface 808 signals comprising commands related to control of the filter wheels of an as associated color correction apparatus. Some commands may specify full or minimal color correction. Other commands may specify an amount of color correction between full and minimal.

In some embodiments, the interface 808 is configured to receive signals that conform to the DMX512 digital communication standard promulgated by the PLASA trade association for the entertainment services and technology. In other embodiments, the interface 808 is configured to receive signals in another suitable format. Such formats include the Remote Device Management (RDM) format and the Art-Net format for use on Ethernet networks.

The controller 802 is also configured to receive via the communications interface 808 signals comprising instructions and/or data for storage in the memory 804. In this way, updates and modifications to the operation of the control system 800 may be made electronically, without requiring physical access to the circuitry of the control system 800.

Although the present disclosure has been described with exemplary embodiments, various changes and modifications may be suggested to one skilled in the art. It is intended that the present disclosure encompass any such changes and modifications as fall within the scope of the appended claims.

What is claimed is:

1. An apparatus configured to color correct a portion of a light beam passing therethrough, the apparatus comprising:
a plurality of filter wheels having a first plurality of regions comprising a color correction filter and a second plurality of regions comprising a clear substrate,
wherein a first subset of the plurality of filter wheels are configured to rotate into corresponding first positions producing a predetermined minimal amount of color correction, and to rotate into corresponding second positions producing a predetermined maximal amount of color correction.

2. The apparatus of claim 1, wherein the first subset of the plurality of filter wheels are configured to rotate to corresponding third positions between the first positions and second positions.

3. The apparatus of claim 1, further comprising:
a first actuator; and
a first coupling member coupling the first actuator to at least a first filter wheel of the first subset of the plurality of filter wheels,
wherein the first actuator and the first coupling member are configured to rotate the first filter wheel from its first position to its second position.

4. The apparatus of claim 3, further comprising:
a second actuator; and
a second coupling member coupling the second actuator to a second filter wheel of the first subset of the plurality of filter wheels,
wherein the second actuator and the second coupling member are configured to rotate the second filter wheel from its first position to its second position.

5. The apparatus of claim 3, wherein the first actuator is manually operable.

6. The apparatus of claim 3, wherein the first actuator is electrically activated, the apparatus further comprising a control system configured to control the first actuator and operable to cause the first actuator to rotate the first filter wheel from the first position to the second position.

7. The apparatus of claim 6, wherein the control system includes a communication interface configured to receive a signal, the control system configured to control the first actuator in response to the signal.

8. The apparatus of claim 3, further comprising:
a second coupling member coupling the first actuator to a second filter wheel of the first subset of the plurality of filter wheels,
wherein the first actuator and the second coupling member are configured to rotate the second filter wheel from its first position to its second position.

9. The apparatus of claim 1, wherein the first subset of the plurality of filter wheels includes all filter wheels in the plurality of filter wheels.

10. The apparatus of claim 1, wherein one of:
in the first positions of the first subset of the plurality of filter wheels, the first plurality of regions of the plurality of filter wheels are substantially aligned; and
in the second positions of the first subset of the plurality of filter wheels, substantially all portions of the light beam pass through a color correction filter region of at least one filter wheel.

11. A lighting fixture, comprising:
a light source configured to emit a light beam; and
a color correction apparatus configured to color correct a portion of the light beam, the apparatus comprising:
a plurality of filter wheels having a first plurality of regions comprising a color correction filter and a second plurality of regions comprising a clear substrate,
wherein a first subset of the plurality of filter wheels are configured to rotate into corresponding first positions producing a predetermined minimal amount of color correction, and to rotate into corresponding second positions producing a predetermined maximal amount of color correction.

12. The lighting fixture of claim 11, wherein the first subset of the plurality of filter wheels are configured to rotate to corresponding third positions between the first positions and second positions.

13. The lighting fixture of claim 11, wherein the color correction apparatus further comprises:
a first actuator; and
a first coupling member coupling the first actuator to at least a first filter wheel of the first subset of the plurality of filter wheels,
wherein the first actuator and the first coupling member are configured to rotate the first filter wheel from its first position to its second position.

14. The lighting fixture of claim 13, wherein the color correction apparatus further comprises:
a second actuator; and
a second coupling member coupling the second actuator to a second filter wheel of the first subset of the plurality of filter wheels,
wherein the second actuator and the second coupling member are configured to rotate the second filter wheel from its first position to its second position.

15. The lighting fixture of claim 13, wherein the first actuator is manually operable.

16. The lighting fixture of claim 13, wherein the first actuator is electrically activated, the lighting fixture further comprising a control system configured to control the first actuator and operable to cause the first actuator to rotate the first filter wheel from the first position to the second position.

17. The lighting fixture of claim 16, wherein the control system includes a communication interface configured to receive a signal, the control system configured to control the first actuator in response to the signal.

18. The lighting fixture of claim 13, wherein the color correction apparatus further comprises:
a second coupling member coupling the first actuator to a second filter wheel of the first subset of the plurality of filter wheels,
wherein the first actuator and the second coupling member are configured to rotate the second filter wheel from its first position to its second position.

19. The lighting fixture of claim 11, wherein the first subset of the plurality of filter wheels includes all filter wheels in the plurality of filter wheels.

20. The lighting fixture of claim 11 wherein one of:
in the first positions of the first subset of the plurality of filter wheels, the first plurality of regions of the plurality of filter wheels are substantially aligned; and
in the second positions of the first subset of the plurality of filter wheels, substantially all portions of the light beam pass through a color correction filter region of at least one filter wheel.
